(19) United States
(12) Patent Application Publication
(10) Pub. No.: US 2013/0021002 A1
(43) Pub. Date: Jan. 24, 2013

(54) Personal Energy Memorial

(71) Applicant: Willard Alan Mayes, Dallas, TX (US)

(72) Inventor: Willard Alan Mayes, Dallas, TX (US)

(21) Appl. No.: 13/543,840

(22) Filed: Jul. 8, 2012

Related U.S. Application Data
(63) Continuation of application No. 61/572,786, filed on Jul. 19, 2011.

(51) Int. Cl. H02J 7/00

(52) U.S. Cl. 320/137

(57) ABSTRACT

In a method for enhancing memorials, a store of energy harvested from the body of a living person or animal, “personal energy,” is used to personalize a memorial. In a preferred approach, harvested personal energy converted to electrical power charges energy storage devices that are subsequently stored inside a memorial and/or used to power the memorial's comprised electronics. Alternatively, a memorial is equipped to harvest, convert, store and then use personal energy to power its own electronic features. Further alternatives are proposed. The present invention builds upon the tradition of including in a memorial certain items that were an intimate part of a deceased loved one's life. Given the especially intimate nature of harvested personal energy, its inclusion enhances the art of personalized memorials.

### FIELD OF THE INVENTION

The present invention relates to methods for memorializing the life of a deceased person or animal, and more particularly to a method for creating a personalized memorial that incorporates a store of energy harvested from the living body of a person or animal. The invention also relates tangentially to energy harvesting from human or animal body sources.

### BACKGROUND OF THE INVENTION

After a thorough research of the prior art, the inventor has come to the conclusion that no prior art teaches or suggests the inclusion or use of energy harvested from the living body of a person or animal in any type of memorial.

Throughout history we have honored our deceased loved ones by creating memorials that allow us to keep the spirit of their past lives with us in the present, from simple urns, to grand monuments. Less formally, we commonly hold onto personal items that were an intimate part of a deceased loved one's life; it seems because we sense that their spirit remains in the personal items, keeping them helps us maintain a bond with the dearly departed person or animal.

Prior art memorials are frequently designed to accommodate this common practice. Made of every possible material and taking forms that have personal relevance to the deceased and their survivors, prior art memorials very frequently include a space or structure that allows for personal items of the deceased loved one to be kept: a photograph, an item of jewelry, a favorite toy, a weapon, eyeglasses, etc. It is also quite common for survivors to include in prior art memorials something from the deceased loved one's body, such as a lock of their hair or their cremated remains. In some cultures, pieces of bone or body parts of the deceased are kept in memorials; in other traditions, memorials go so far as to entomb the entire body of a deceased loved one.

Such relics, personal items or body remains, are valued by many as enduring embodiments of the deceased's one life energy, and the memorial that holds them becomes similarly dear by extension. Many survivors find comfort in believing or just sensing that the memorial is imbued with an intangible yet somehow perceivable energy of their deceased loved one and that they can experience this energy when they touch or merely behold it.

However, because the presence of such energy is not discernible, others would argue that it is actually only inferred by those who believe it exists. A survivor beholding a memorial of prior art has to impart the energy's intangible presence upon the memorial and the items it holds because the energy's reality is reliant upon the survivor believing that it exists and that through some sixth human sense he or she can experience this energy. Absent the believer's input and feeling, the energy's presence in the memorial is not apparent, and its actual presence is thus uncertain.

This uncertainty represents a shortcoming in prior art memorial items, a shortcoming that could be addressed only by an improvement that would make it possible to add to a memorial the actual energy of the person or animal whose life it memorializes. The present invention teaches methods and suggests means for achieving this improvement.

### SUMMARY

It is the object of the present invention to propose methods for personalizing a memorial that overcome a shortcoming of the prior art in the field: uncertainty vis-à-vis the perceived continued presence of the deceased loved one's life energy in the memorial. The invention teaches personalization of a memorial through the association of a store of harvested “personal energy” with a memorial, where it can be kept long term and/or selectively used to power an evincing electronic device comprised in the memorial. Personal energy is defined here as the energy naturally generated by the living body of a human being or animal, such as the thermal energy of body heat or the kinetic energy of movement. Representative physical embodiments of the methods are presented to make clear their inventive nature, hint at how they can be applied in practice, and to point out some aesthetic and practical considerations that may guide producers of personal energy memorials.

A personal energy memorial can take any form. Traditional forms have included wooden chests, urns, vases, plaques, frames, busts, sculptures, pendants, bracelets, and etcetera. What will be the common distinguishing characteristic of a personal energy memorial of any form is its personalization with a store of personal energy harvested from the person or animal subject of the memorial. In addition to structures and/or spaces for holding such a store of personal energy, a personal energy memorial will preferably also comprise at least one electronic device that is powered by the same or similar energy storage device which has been charged with the subject's harvested personal energy.

The present disclosure proposes two general approaches to harvesting personal energy and creating a store of the harvested energy. One approach suggests external harvesting and charging apparatus, while a second approach teaches comprising one or both of these components in a memorial itself. These two general approaches are exemplified in three representative physical embodiments.

In a first representative embodiment, an otherwise conventional wooden chest memorial becomes a personal energy memorial, a place where the harvested personal energy of a deceased loved one can be kept for many years after he, she or it (animal) has passed away, and occasionally evinced through the memorial's comprised electronic feature, an electroluminescent lamp. Two alternative ways and means are proposed for charging a custom-made energy storage device with the subject's harvested personal energy.

In a second representative embodiment, a credit-card sized powered card is proposed as a memorial. The “powered memorial card” comprises its own evincing electronic feature, an electroluminescent lamp, that it powers with mounted thin-film batteries that have been charged with the subject's harvested personal energy. Harvesting and charging are accomplished with separate, external devices. Whereas the wooden chest memorial would generally be a stationary item, a powered memorial card could be carried in a pocket, purse or wallet.

In a third representative embodiment, the powered memorial card just described is outfitted with its own micro-energy harvesting module, a thermoelectric generator (TEG), to create a “self-powered memorial card” that is capable of harvesting, converting, storing, and then using the subject's harvested personal energy to operate its own electronic device.

Existing technology offers several ways and concomitant devices for harvesting energy from human or animal sources. It is not the purpose of the present invention to teach or disclose an energy harvesting method or device, but rather how to utilize these for personalizing a memorial with harvested personal energy. Thus, only a brief and general review of energy harvesting is included and some preferences stated.

A single personal energy memorial can be associated with the personal energy of one or more persons, animals, or persons and animals. The subject or subjects' personal energy can be harvested firsthand or secondhand. A personal energy memorial can have one or more electronic devices, with one, some or all powered by the subject or subjects' harvested personal energy in a variety of arrangements.

The length of time an electrical energy storage device can retain a useful charge, once fully charged, is of primary consideration for its inclusion in a personal energy memorial. A particular thin-film battery with an at least 20-year charged shelf life is identified and stated as preferred herein.

An essential element of the methods disclosed herein is energy harvesting from human or animal sources. One general approach to this type of energy harvesting is to employ micro-energy harvesting devices, which harvest very small amounts of energy collected over an extended period; for example, thin-film piezoelectric and thermoelectric generator modules. Micro-energy harvesting, alternately referred to as “micro-harvesting,” is essentially a passive form of harvesting that can require little intentional effort from the subject. Furthermore, the harvesting subject can wear micro-harvesting devices without interference to their movement; thus, the personal energy of even athletes actively engaged in sports could be harvested as they perform. Conversely, the personal energy of a weak or incapacitated person or animal could be harvested passively with a micro-harvesting device.

Another solution is the use of a manually operated mechanical electric generator, whereby a person or animal mechanically inputs and converts their muscle energy (biomechanical energy) to electrical power. While the term “energy harvesting” has come for many to refer to today's micro-energy harvesting technology, in fact some energy harvesters are large mechanisms and have been around for a very long time; windmills, for example. A manually operated mechanical electrical generator is a personal energy harvester; it captures the energy of the operator and translates the energy to useful electrical power. It can generate a vastly greater amount of electrical energy than a micro-harvesting device, and in a far shorter period of time. This could appeal as a convenience factor to some, especially those who would like to harvest a large store of energy from a human or animal source. In contrast to micro-harvesting methods, harvesting personal energy with a manually operated generator would normally require the person or animal's active participation.

### BRIEF DESCRIPTION OF THE SEVERAL DRAWINGS

FIG. 1 is a flowchart that depicts an overall method by which a personal energy memorial is created.

FIG. 2 is a front perspective view of a wooden chest memorial, the first of two components that together make up the first representative embodiment of the present invention.

FIG. 3 is a front perspective view of a so-called “battery card,” the second of two components that together make up the first representative embodiment.

FIG. 4 is a rear perspective view of the battery card of the first representative embodiment shown in FIG. 3.

FIG. 5 illustrates the stacking of thin-film batteries in parallel configuration as they are arranged and mounted on the back of the battery card of the first representative embodiment shown in FIGS. 3 and 4.

FIG. 6 illustrates the battery card shown in FIGS. 3 and 4 inserted into a card receiving slot configured in one side of the wooden chest shown in FIG. 2.

FIG. 7 is a schematic illustration of an electrical circuit made complete by the insertion of the battery card shown in FIGS. 3 and 4 into an electronic apparatus disposed within the wooden chest memorial of the first representative embodiment shown in FIG. 2.

FIG. 8 is a rear perspective view of the wooden chest memorial of the first representative embodiment.

FIG. 9 is a second rear perspective view of the wooden chest memorial of the first representative embodiment.

FIG. 10 is a front perspective view of a possible charging station designed for charging/discharging the battery card shown in FIGS. 3 and 4.

FIG. 11 illustrates the structure of a thermoelectric generator that is comprised in a self-charging battery card shown in FIG. 12.

FIG. 12 is a front perspective view of a self-charging battery card comprising a thermoelectric generator shown in FIG. 11.

FIG. 13 is a rear perspective view of the self-charging battery card shown in FIG. 12.

FIG. 14 is a flowchart depicting a method for personalizing the wooden chest memorial shown in FIG. 2 with harvested personal energy via the battery card shown in FIGS. 3 and 4.

FIG. 15 is a front perspective view of a second representative embodiment, a powered memorial card.

FIG. 16 is a rear perspective view of a second representative embodiment, a powered memorial card.

FIG. 17 is a flowchart that depicts a method for personalizing the second representative embodiment, a powered memorial card, with personal energy harvested from the subject of the memorial.

FIG. 18 is a front perspective view of a third representative embodiment, a self-powered memorial card comprising a thermoelectric generator.

FIG. 19 is a rear perspective view of a third representative embodiment.

FIG. 20 is a second front perspective view of the third representative embodiment shown in FIG. 18 illustrating an alternative design.

FIG. 21 is a flowchart that depicts a method for personalizing the third representative embodiment with personal energy harvested from the subject of the memorial.

### DETAILED DESCRIPTION OF THE INVENTION AND REPRESENTATIVE EMBODIMENTS

For efficiency, the pronouns “their”, “they” and “them” are sometimes used in this disclosure as gender-neutral pronouns referring to singular or plural nouns, as is common in English usage today. The term “personal energy” is used herein to refer to energy that is produced naturally by the living body of a human being or animal; “harvested personal energy” is such energy collected by an energy harvesting device. While the term “energy harvesting” has come for many to refer to today's cutting edge technology for micro-energy harvesting of ambient energy, in fact some energy harvesters are large mechanisms and have been around for a very long time; windmills, for example. In this disclosure the definition of “energy harvesting device” shall include a mechanical electric generator that is manually operated by a person or animal, the definition of “personal energy” above given shall encompass the energy expended thereby, and when harvested, this energy shall be understood to be “harvested personal energy.”

As used herein, the term “personalize” refers to the action of adding to an object something which facilitates the object being distinctly associated with a particular person or persons, or animal(s). As used herein, the term “subject” refers to the person and/or animal memorialized by a particular memorial, and the terms “human being” and “person” are used alternately with the same meaning. The term “and/or” as used in this disclosure includes any and all combinations of one or more of the items associated or listed. The singular forms “a,” “an” and “the” are intended to include plural forms as well, unless clearly defined or indicated otherwise in the context they appear. When the terms “comprise(s),” “comprised” and/or “comprising” are used, they specify the presence of a stated component, item, feature, etc., but do not preclude the presence or addition of other features, components, items, and etcetera. Terms used in this disclosure are intended to have meanings consistent with their meanings in the context of the art and their meanings should not be contracted, expanded or construed to have different meanings or interpretations unless they are defined in such a way in this disclosure. It will be understood that different orientations are possible in addition to the orientations depicted in the figures.

A personal energy memorial is a memorial that comprises at least a space, structure and/or component that make(s) it possible for a store of energy harvested from the living body of the memorial's human or animal subject to be held in, on or with the memorial and/or be used to power an evincing electronic device that stimulates one or more of the five human senses, directly or indirectly. This harvested energy is referred to herein as “personal energy.” A subject's personal energy is harvested while they are still alive; the harvested personal energy is converted to electrical power, which is stored, by a charging process, in one or more energy storage devices, such as, but not limited to, batteries or capacitors.

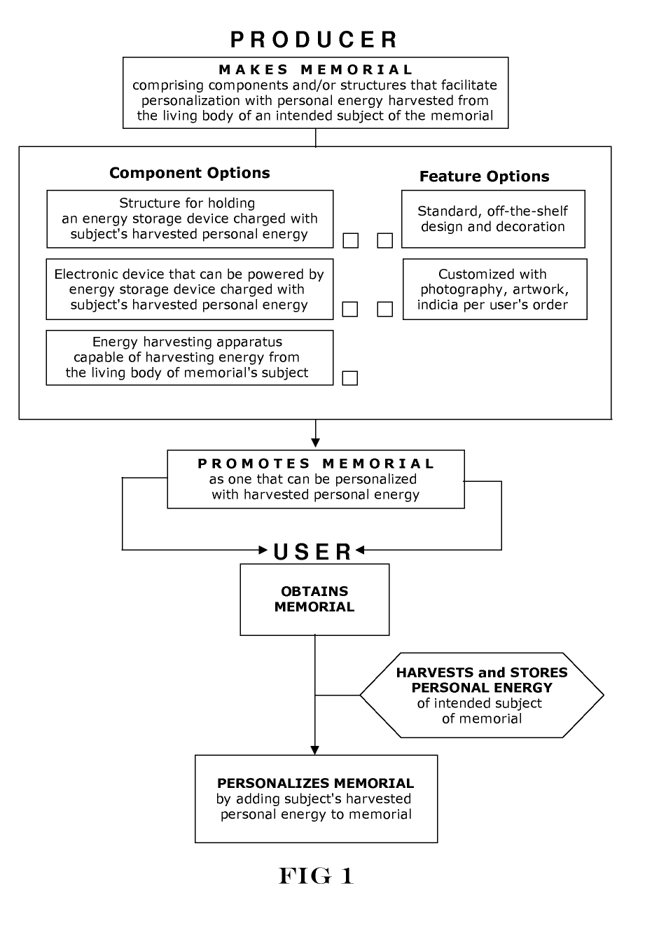

The creation of a personal energy memorial will generally happen in two phases: production and personalization. A memorial product that is structured and outfitted to serve as a personal energy memorial is made, provided and promoted; then, it is personalized with the harvested personal energy of the subject, i.e. the person(s) or animal(s) to be memorialized. Generally, separate parties, a producer and a user, will carry out these tasks. Likely, the producer will be a person or business that produces memorials and the user a customer who purchases a memorial from them, directly or indirectly, and personalizes it with his/her own or a significant other's harvested personal energy. The user may him or herself be the subject of the memorial. FIG. 1 illustrates by flowchart this relationship and the method of creating a personal energy memorial it facilitates. In certain circumstances, the producer could both produce a memorial and personalize it with personal energy. For example, in the case of a memorial made for a person of frame and significance, a producer may be tasked with creating the memorial, harvesting and storing energy from the significant subject, and adding the stored harvested energy to the memorial before delivering it.

FIG. 1 also illustrates several fundamental design decisions a producer will need to make. The configuration of a memorial intended to serve as a personal energy memorial will vary depending on the needs, preferences and abilities of the users. Some users may wish to have only a place to keep a store of a deceased loved one's harvested personal energy, others a personal energy memorial that only evinces the energy electronically, and still others a memorial that can both keep and evince the energy. With regards to how the personal energy is harvested and stored, some users may want a memorial that comes with its own energy harvesting and/or its own charging apparatus, while others may want to harvest their or their loved one's personal energy in ways separate of the memorial itself. Finally, the memorial may be delivered as a standard “off-the-shelf” model or one that has been or can be personalized in conventional ways, such as with photographs, artwork and/or indicia.

Energy harvested from human or animal sources is a defining element of the present invention. However, the invention does not teach nor rely on any one particular method for harvesting energy. The energy harvesting and storing apparatus are described as external to the memorial in two of the three representative embodiments proposed herein; however, as the third representative embodiment demonstrates, fitting a memorial with its own, integral energy harvesting apparatus is also a feasible solution.

The first representative embodiment requires preparation of a custom battery structure that comprises extremely thin and lightweight thin-film solid-state batteries. Because the thin-film batteries will be handled outside laboratory or factory conditions, they need to be mounted on a substantial substrate to make their use practical in the present invention. A plastic celluloid card of credit card form factor is proposed as the substrate. The term “battery card” is proposed for this custom battery structure and will be used hereinafter to refer to it.

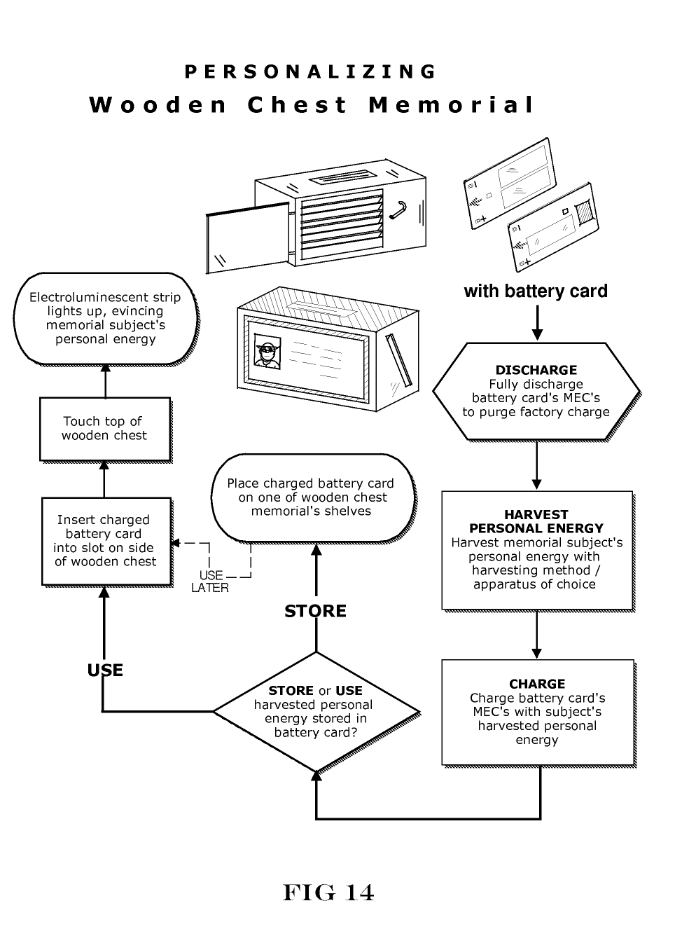

The first representative embodiment of the present invention has two components that together yield a personal energy memorial: a wooden chest memorial 10 and a custom battery structure, referred to herein as a battery card 11. The battery card 11, charged with personal energy harvested in life from the body of the memorial's intended subject, personalizes the wooden chest memorial in two ways: it can be stored in the wooden chest memorial 10 and/or it can be used to power an electronic device comprised by the wooden chest memorial 10. FIGS. 2-13 illustrate various aspects of the first representative embodiment, and FIG. 14 schematically illustrates the method by which a user personalizes the wooden chest memorial 10 with the subject's harvested personal energy to complete the creation of a personal energy memorial of the present invention.

On the front surface of the wooden chest memorial 10, as shown in FIG. 2, there is a photograph 20 of the subject of the memorial and indicia 21, represented in FIG. 2 by a set of dashed lines. The indicia 21 may identify the subject; it might also include a quote, a poem, a religious verse or the like that is relevant to subject's life. Arranged along all four outer edges of the front surface of the wooden chest memorial 10 is a single, continuous electroluminescent (EL) strip 22, which is chosen as the evincing electronic device in this first representative embodiment for two reasons: its light and its exceptional efficiency. Human beings associate light with life, thus the preferred type of evincing electronic device used in a personal energy memorial is one that produces light, preferably a light that has a warm and glowing appearance, such as an electroluminescent lamp.

Moreover, it is an aim of the present invention to provide survivors with a long-lasting store of their deceased loved one's personal energy. Once the subject of the memorial has passed away, additional personal energy cannot be harvested; therefore, if an electronic device powered by the subject's harvested personal energy is to be included in a personal energy memorial design or system, efficiency and frugality of use should be kept in mind when selecting the device. Electroluminescent lamps are highly efficient, using about forty percent less energy than light emitting diodes of similar specifications. Of course, producers of personal energy memorials will respond to the preferences and needs of their customers when deciding what electronic components, if any, to include, and may find another type of evincing electronic better suited to their personal energy memorial product.

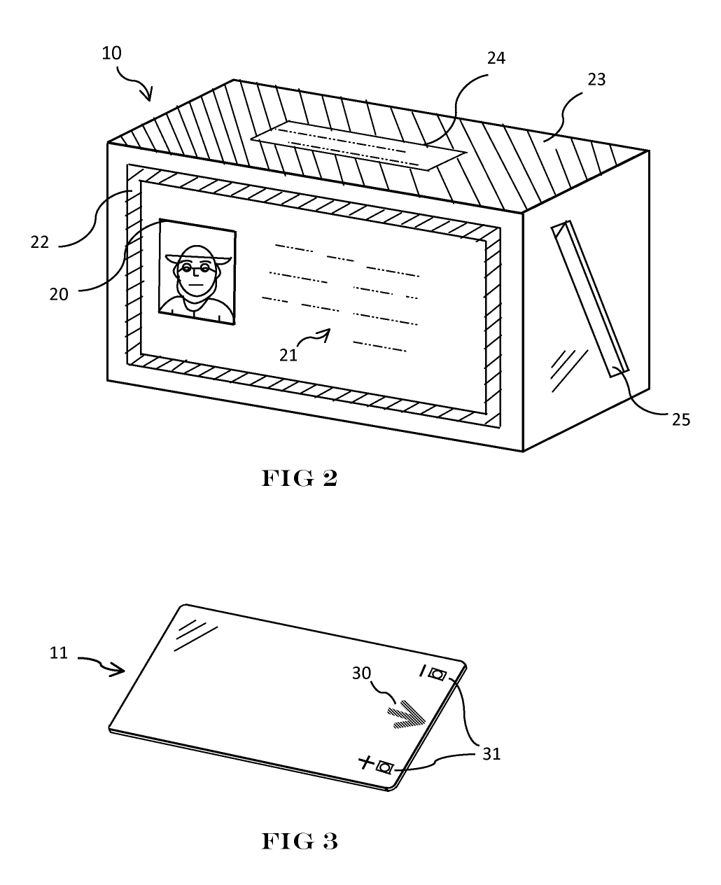

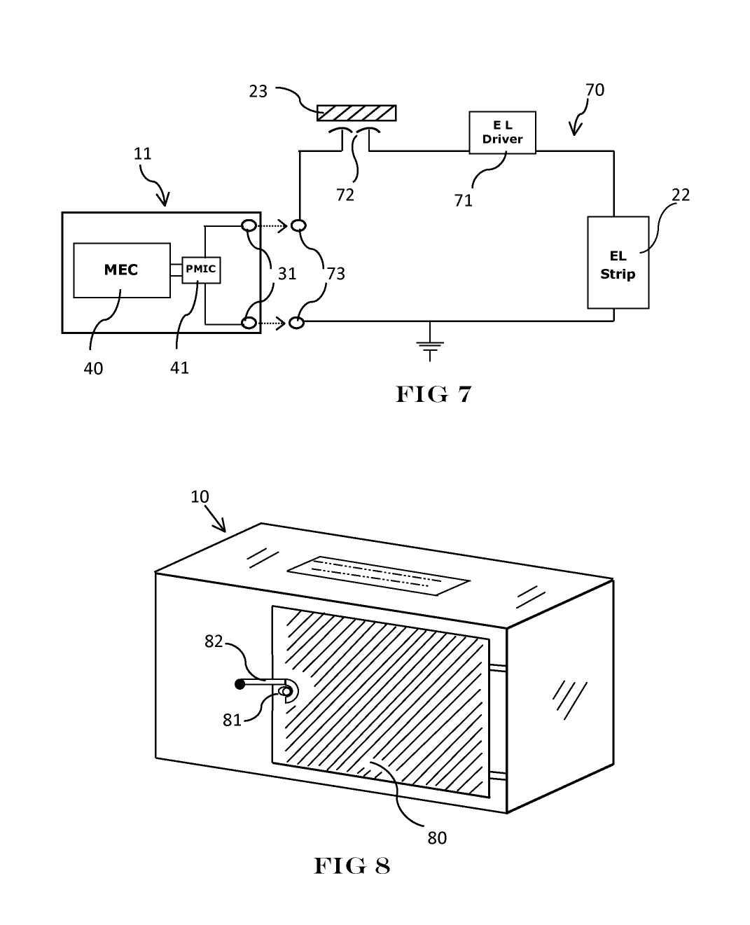

The top surface of the wooden chest memorial 10 is plated with a thin metal facade 23 that serves as the user interface surface of a touch switch 72, shown in FIG. 7, that turns on or off the EL strip 22 when touched. A second indicia area 24 is centered on the metal facade 23. When a battery card 11, illustrated in FIGS. 3-5, charged with energy harvested from the living body of the subject is inserted into a slot 25 on the right side of the wooden chest memorial 10, a user can operate the EL strip 22 by touching the metal façade 23. The EL strip 22 emits a soft glowing light of a single color that serves several functions: to illuminate the wooden chest memorial 10, to evoke a mood, and, most significantly, to evince the personal energy of the subject of the memorial and thereby evidence its presence. The EL strip 22 “fades in” when turned on, and “fades out” when turned off; the personal energy evinced by the EL strip 22 thus seems to gently wake or go to sleep in response to a user's touch of the metal facade 23 top of the wooden chest memorial 10. A so-called EL driver 71, shown in FIG. 7, facilitates this latter function.

In a “simplest form” example, the front of the battery card 11 is blank, except for a printed arrow 30 that indicates the leading edge of the battery card 11, where two contact posts 31 are configured and marked for polarity. The front surface could be covered with a final layer of plain matte film that would allow a user to handwrite the name and other information relevant to the person or animal whose harvested personal energy is stored in the battery card 11. In less simple alternatives, the front of the battery card 11 could have standard or customized pre-printed artwork, photography and/or indicia that are applied by the battery card's 11 producer.

The primary purpose of the present invention is to provide survivors with a store of energy harvested in life from a loved one that can be kept and possibly evinced occasionally for many years after the loved one has died. Therefore, charged shelf life, i.e. the length of the period of time that an energy storage device can maintain an operational charge when stored and not used, should be a fundamental consideration when selecting an energy storage device to be used with a personal energy memorial. The preferred energy storage device at this time for the present invention is a micro-energy cell (MEC) type of battery produced by Infinite Power Solutions (IPS) of Littleton, Colo. in USA and marketed under the brand name THINERGY®. These rechargeable, solid-state, thin-film batteries are designed specifically for energy harvesting applications. More significantly, they have an exceptional estimated charged shelf life of twenty years or more. A battery with a long shelf life adds tremendous intrinsic emotional value to a personal energy memorial, as both the subject of the memorial and their survivors can take comfort in the knowledge that the harvested personal energy will reside with and/or can be evinced through the memorial long after they or their loved one has passed away.

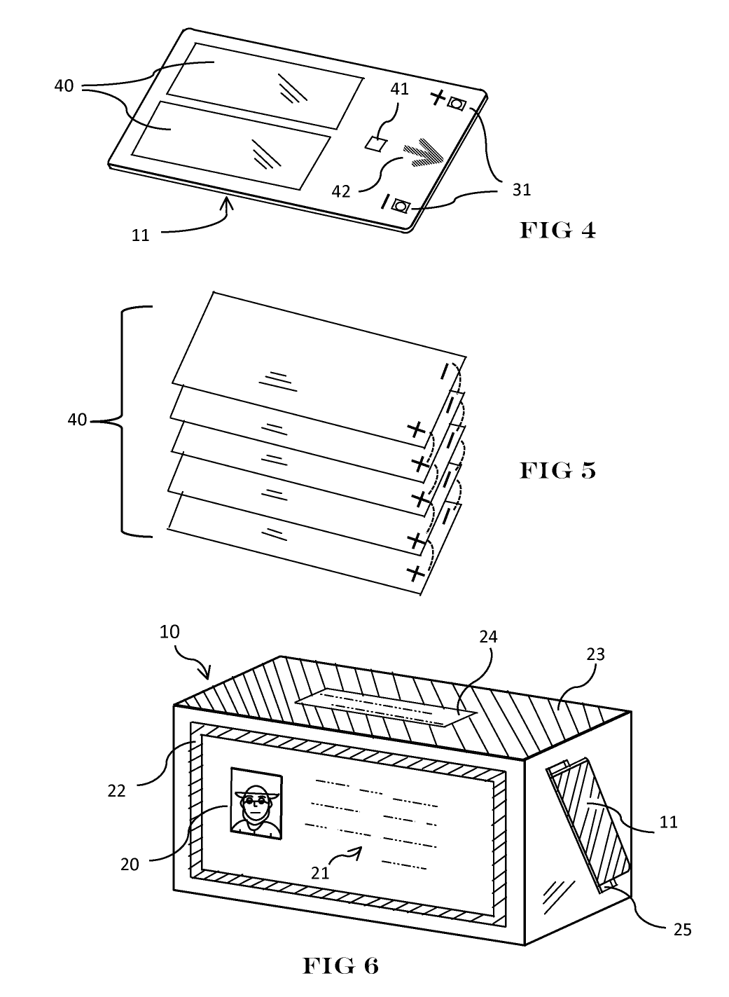

FIG. 4 reveals the electronic components and circuitry that make the battery card 11 an energy storage device. Mounted on the back of the battery card 11 are ten rechargeable THINERGY® micro-energy cells (MEC's) 40, arranged in two vertical stacks, each stack comprising five MEC's 40 stacked in parallel configuration, as illustrated in FIG. 5. The other sides of the battery card's 11 already identified two contact posts 31 are seen in this rear view, and between them is a second printed arrow 42, once again indicating the leading edge of the battery card 11. A power management integrated circuit (PMIC) is required to manage micro-energy cells; accordingly, also operatively mounted on the back of the battery card 11 is a PMIC 41. The preferred power management integrated circuit for the representative embodiments of this disclosure is the MAX 17710, a thin-film integrated circuit made by Maxim Integrated Products of Sunnyvale, Calif. in USA and designed specifically for managing THINERGY® micro-energy cells.

When the battery card 11 is inserted into the slot 25, its contact posts 31 come into contact with contact posts 73 and completes an electronic circuitry 70 disposed within the wooden chest memorial 10, as illustrated in FIGS. 6 and 7. An EL driver 71 conditions voltage from the MEC's 40 to make it suitable for operating the EL strip 22, which is additionally configured to fade in and fade out. The schematic illustration of FIG. 6 is a simple representation to exemplify and show feasibility; extending, limiting and/or intervening components and circuitry would likely be necessary in a real world application, and other circuit designs could fulfill the same purpose.

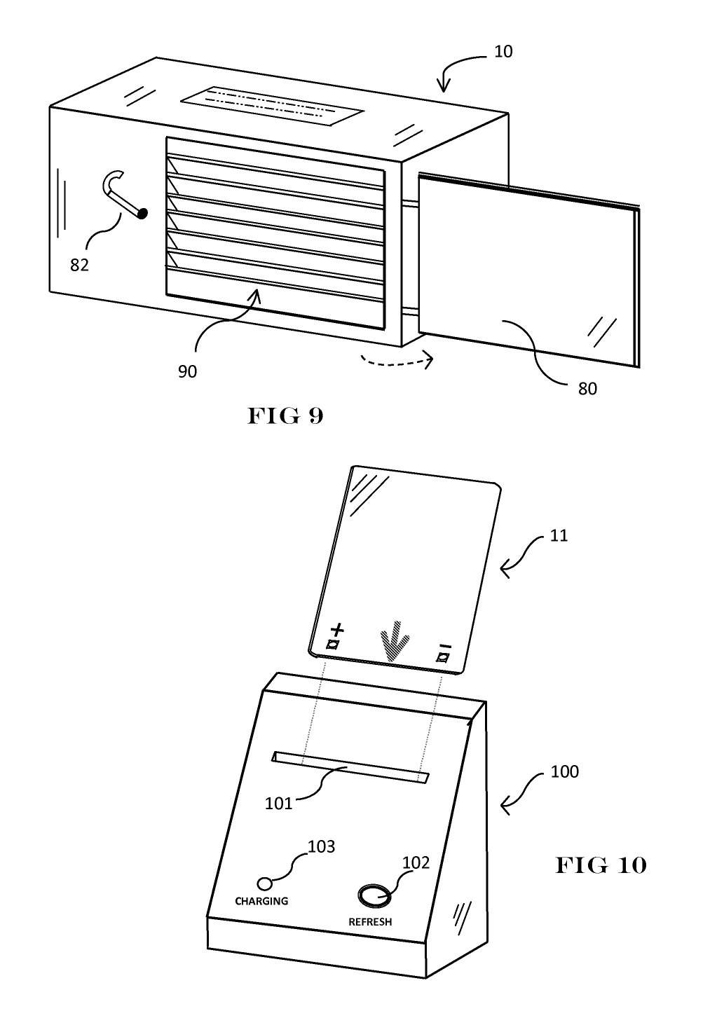

The first exemplary embodiment, the wooden chest memorial 10, can be additionally personalized by storing within it battery cards 11 that have been charged with the subject's harvested personal energy. In the rear of the wooden chest memorial, as shown in FIG. 8, there is a hinged door 80, which is closed in this view. A knob 81 assists in opening the door 80, and a simple hook-and-eye latch 82 secures the door 80 in a closed position. In FIG. 9 the door 80 is shown in an open position, revealing a set of storage shelves 90 arranged inside the wooden chest memorial 10 specifically for storing a number of battery cards 11 that have been charged with the personal energy of the subject of the wooden chest memorial 10. The storage shelves 90 correspond substantially in size and shape to a battery card 11 and are tilted inward so that stored battery cards 11 do not readily spill out when the door 80 is opened. When the door 80 is closed, there is very little free space between the outer edges of the storage shelves 90 and the door 80 so that the battery cards 11 are secured in the storage shelves 90 even when the wooden chest memorial 10 is handled or moved. In this manner, given the MEC's 40 exceptionally long charged shelf life, the harvested personal energy of the departed subject can reside within the wooden chest memorial 10 for many decades.

In designing a personal energy memorial that offers both storage and evincing electronic features, as this first representative embodiment does, a balance needs to be struck between the benefits of using the harvested personal energy versus the comfort that keeping the personal energy long term provides the deceased loved one's survivors. For example, in more sophisticated alternative designs, the EL strip 22 could perhaps emit more than one color, alternate between or among two or more colors, blink, simulate animation, depict an image, or spell out words or phrases. However, more sophisticated functions like these would place greater demand on the limited store of harvested personal energy comprised in the stacked MEC's 40. Ultimately, producers and users will decide where the balance between using and storing this limited resource should lie.

Because the battery card 11 is not a standard form of battery, a specialized charging station that can charge the proposed battery card 11 is needed. Of course, the battery card 11 could be charged directly, using wires from a selected harvesting apparatus and so-called “banana clips” connected to the battery card's 11 contact posts 31. However, this would not be a practical, user-friendly solution. FIG. 10 shows a proposed charging station 100 designed specifically for the battery cards 11 of this first representative embodiment. A battery card 11 can be inserted into a slot 101 to make contact with a typical charging/discharging electronic apparatus within (not shown). An LED 103 marked “CHARGING” indicates when a battery card 11 is charging or fully charged.

Before charging the battery card 11, a preparatory discharging step needs to be taken to ensure the battery card's 11 stacked MEC's 40 comprise a store of energy that is as exclusively the harvested personal energy of the wooden chest memorial's 10 intended subject as possible. New micro-energy cells, like most batteries, come fully charged with energy conventionally produced by the manufacturer or its local electrical utility. This energy needs to be discharged and replaced with the memorial subject's harvested personal energy. Pressing the REFRESH button 102 on the proposed charging station 100 prompts the charging station 100 to fully discharge the battery card 11 (i.e., its mounted MEC's 40). The battery card's 11 integrated PMIC 41 protects the MEC's 40 against damage by managing both the charging and discharging processes.

Another special characteristic of the preferred THINERGY® micro-energy cell (MEC) batteries is an exceptional depth of discharge (DOD). When fully discharged, 99% of their standard factory charge can be expended. Thus, by fully discharging the MEC's 40 before recharging them with energy harvested from the living body of the subject, the MEC's 40 can be, for all intents and purposes, charged exclusively with the subject's harvested personal energy, a characteristic that enhances even further the intrinsic sentimental value of a personal energy memorial personalized with harvested personal energy stored in an MEC battery structure.

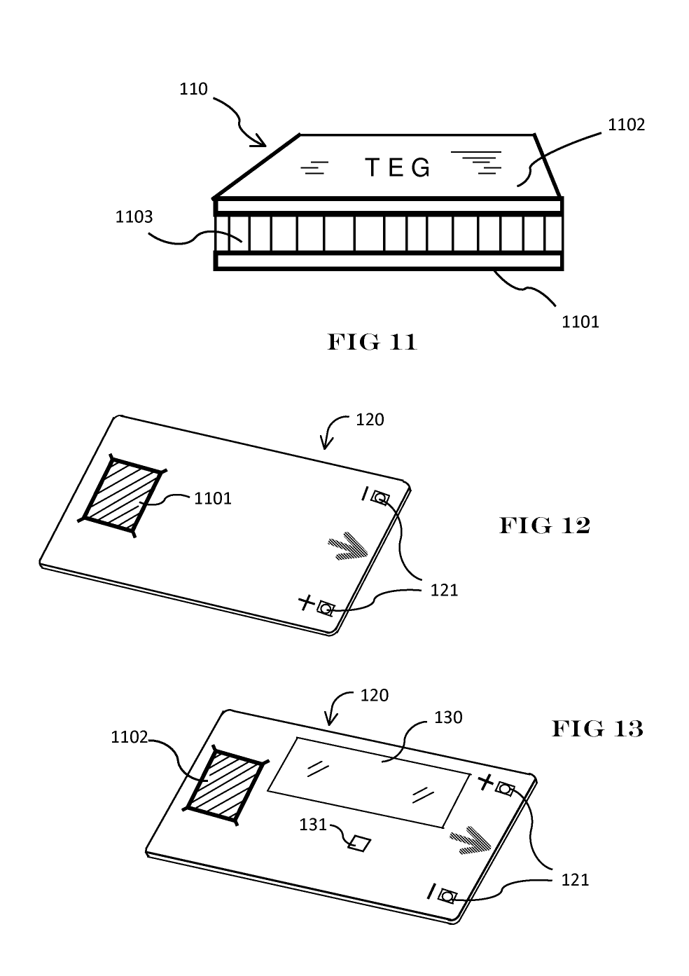

An alternative approach to charging such a proposed battery card 11 would be to outfit it with its own energy harvesting capability to create a “self-charging” battery card: a battery card that could harvest the energy it needs to charge itself. For example, the battery card 11 could be outfitted with a thermoelectric generator (TEG) to harvest thermal energy from the subject's body. The preferred source of personal energy harvested for the present invention is body heat; human beings associate the warmth of the body with the life and spirit of a living person or animal, and sharing this warmth is a bonding experience. An example of a TEG that is specialized to this type of harvesting is the thin-film, flexible, wearable, and customizable ThermoLife® module produced by a division of Perpetua Power Source Technologies Inc. of USA. Thermoelectric generators exploit the Seebeck effect, a phenomenon by which temperature differences between two dissimilar metals in a circuit results in thermal energy being converted to an electric current. Thus, as illustrated in FIG. 11, a TEG 110 has two planar surfaces, a “hot side” 1101 and a “cold side” 1102, which sandwich a number of thermopiles 1103.

FIGS. 12 and 13 illustrate a self-charging battery card 120, which, in order to reduce redundancy, may alternately be referred to hereinafter as simply “the battery card 120.” The battery card 120 is similar to the battery card 11, but additionally comprises the TEG 110 of FIG. 11, which is mounted via a window cut out from the battery card 120 such that its hot side 1101 is exposed at the front of the self-charging battery card 120, while its cold side 1102 is exposed at the back. The electrical current generated by the TEG 110 charges a single stack of ten MEC's 130, arranged in parallel configuration and mounted on the back of the battery card 120. To charge the battery card 120 with harvested personal energy, the intended subject of the wooden chest memorial 10 would need only to keep one side of the battery card 120 in contact or close proximity to the warm surface of their skin and the other side exposed to the ambient temperatures of their environment. Being of the same form factor and comprising the same type of contact posts 121 as the battery card 11, once charged, the self-charging battery card 120 could be used just as the previously described battery card 11 to personalize the wooden chest memorial 10. Where the battery card 11 is referred to in this disclosure, it should be understood then that this alternative self-charging battery card 120 could similarly be referred to.

A new self-charging battery card's 120 mounted MEC's 130 could be fully discharged just as a new battery card's 11 MEC's 40 are discharged using the proposed charging station 100. Alternatively, to eliminate the need for a charging station all together, a new self-charging battery card's 120 MEC's 130 could be discharged of their factory charge by using the battery card 120 to power the EL strip 22 until the EL strip 22 no longer emits light, indicating the MEC's 130 have been fully discharged and disengaged by action of the PMIC 131.

Since the TEG 110 will generate electrical current whenever a temperature difference exists between its hot side 1101 and its cold side 1102, absent an intervening component, it is likely that the self-charging battery card's 120 mounted MEC's 130 would be charged with energy incidentally harvested from sources other than the memorial subject's body. To prevent this, a switch and circuitry could be added to the self-charging battery card's 120 design that would let a user selectably enable or disable the charging function. A similar challenge would need to be addressed with other onboard energy harvesting devices; for example, a device that harvests kinetic energy made available by the movement of the subject's body could generate electrical current when moved in any other situation, such as in shipping and handling.

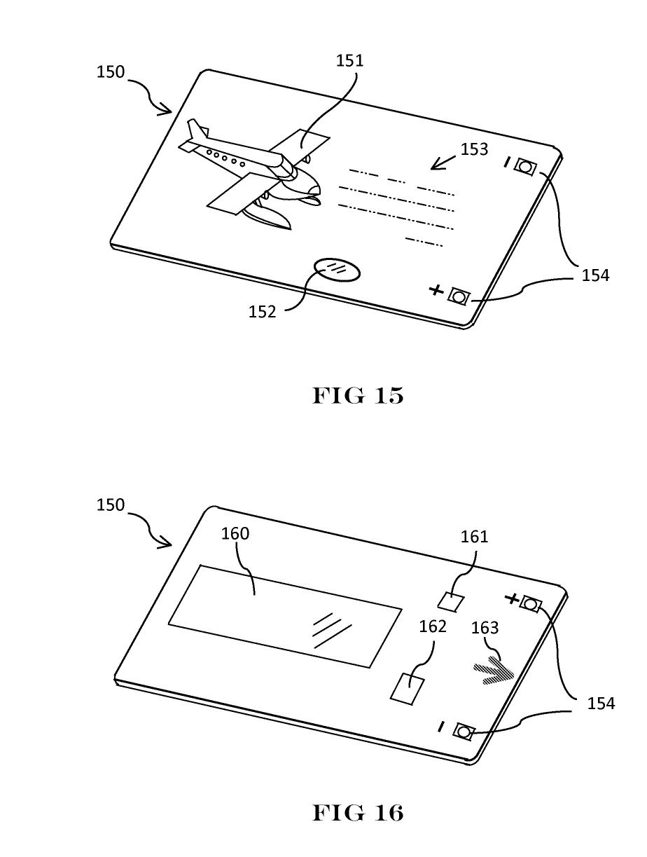

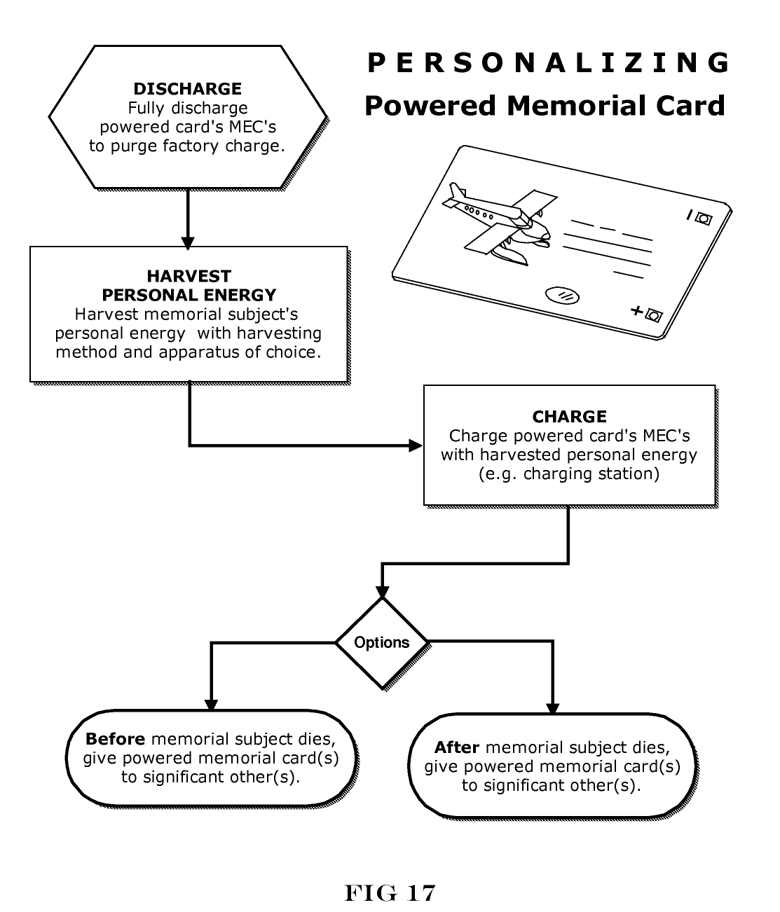

In a second representative embodiment, a powered card similar to the battery card 11 of the first representative embodiment but which comprises its own evincing electronic device serves as a personal energy “powered memorial card.” Many copies of a powered memorial card could be produced ahead of the subject's death and given out to friends and family members before or after the subject has passed away. Because a powered memorial card is of credit card form factor, recipients could carry the memorial in a wallet, purse or personal organizer, just as they would a portrait, to remind them of their deceased loved one and to have the loved one's personal energy always near and present, occasionally evincing the energy through the powered memorial card's own electronic device. This second representative embodiment is illustrated in FIGS. 15-16, and the overall process by which a user personalizes an otherwise typical powered card to create a personal energy memorial of this second representative embodiment type is schematically illustrated in FIG. 17.

FIG. 15 shows the front of a powered memorial card 150 that memorializes a person whose life joy was flying a vintage seaplane. To reduce redundancy, hereafter the powered memorial card 150 may alternately be referred to simply as “the card 150.” The card 150 is a celluloid plastic card generally of credit card form factor. An electrolumiscent (EL) sheet 151 cut to the shape of a seaplane, with an illustration of a seaplane printed on it, is mounted on the front of the card 150. A dome switch 152 powers on or off the EL sheet 151 when pressed. Printed indicia 153, represented in FIG. 15 by a set of dashed lines, identify the subject of the powered memorial card 150, and could also include a poem, a quote, a verse, or the like that is relevant to the deceased subject's life; in this case, perhaps something that complements the theme suggested by the EL sheet's 151 seaplane image would do well. Contact posts 154 facilitate charging the powered memorial card 150 via the proposed charging station 100 of FIG. 10, or by another arrangement, with energy harvested in life from the body of the memorial's subject. Once so charged, the powered memorial card 150 is personalized with the subject's personal energy and is a personal energy memorial of the present invention.

Mounted on the back of the card 150, shown in FIG. 16, is a single stack of five micro-energy cells (MEC's) 160. The MEC's 160 are stacked vertically in parallel configuration, as illustrated in FIG. 5. The stacked MEC's 160 can be charged with electrical energy translated from any suitable personal energy harvesting method and concomitant apparatus that appeal to the manufacturer and/or user of this type of personal energy memorial. More micro-energy cells could be stacked similarly, or other battery types or brands could be used to meet a design demand or achieve a desired performance.

Also mounted on the back of the powered memorial card 160 are a power management integrated circuit (PMIC) 161 and an electroluminescent (EL) driver 162. The PMIC 161 manages the charging and discharging of the stacked MEC's 160 and protects them against damage; the EL driver 162 conditions voltage supplied by the MEC's 160, making it suitable for powering the EL sheet 151. The EL driver 162 could be configured to “fade in” and “fade out” the EL sheet 151 for a better user experience. A printed arrow 163 indicates the leading edge of the card 150, the edge that should be inserted into a specialized charging station, such as the proposed charging station 100 shown in FIG. 10.

Alternatively, a photograph or illustration of the deceased subject could be printed on the EL sheet 151, which would instead be cut to the shape of a portrait frame and would backlight the photograph when powered. Further, while the powered memorial card 150 is a complete personal energy memorial itself, because it has contact posts 154, with a few alterations to its circuitry it could become a “crossover” model that could additionally and alternatively be used to power other personal energy evincing devices, such as the EL sheet 22 of the wooden chest memorial 10 and other personal energy memorials that feature an evincing electronic device.

In some special cases, such as when a powered memorial card is to memorialize a famous person, a producer may carry out the harvesting of the subject's personal energy and charge a large number of powered memorial cards with the harvested energy before providing them to a client or the market. In such a case, there would be no need for the powered card memorial to be charged by an end user, and so an alternative version that does not have contact posts could be made. The contact posts may remain a part of such a powered card memorial, though, if the card were intended to be a “crossover” model of the type described in the previous paragraph.

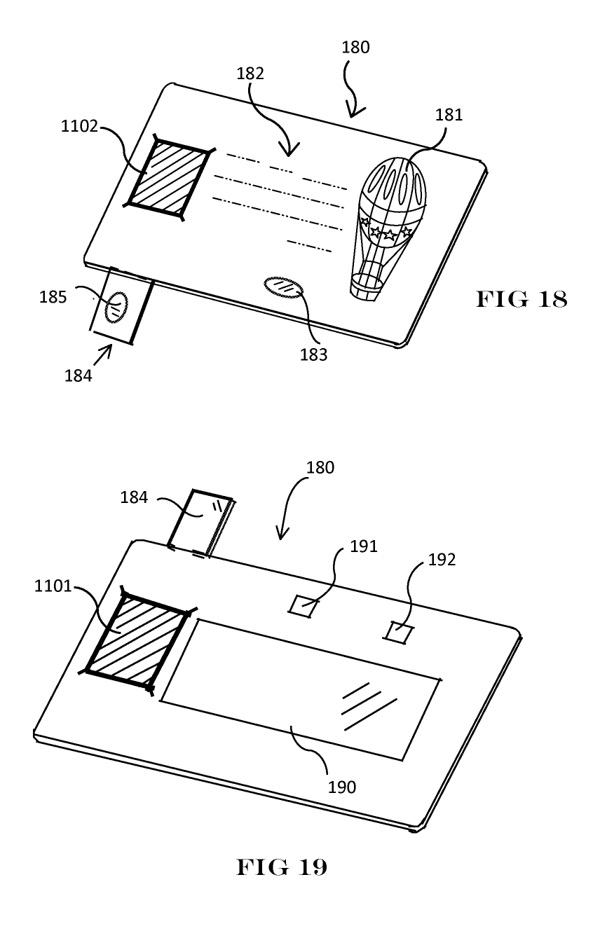

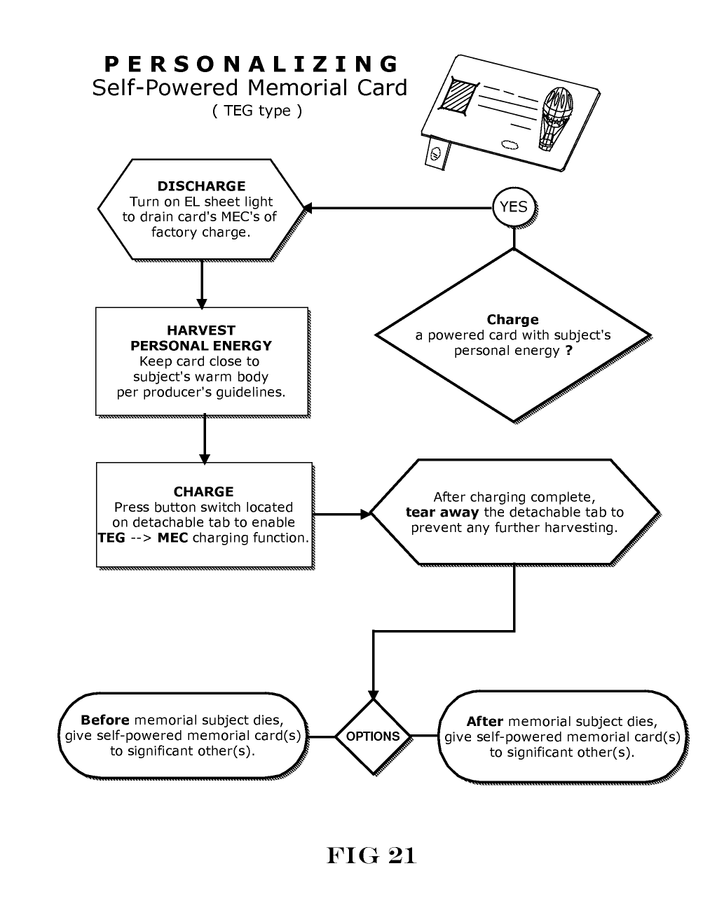

A third representative embodiment of the present invention teaches a “self-powered memorial card,” which is similar in features to the powered memorial card 150; however, like the alternative self-charging battery card 120, comprises its own energy harvesting means, a thermoelectric generator (TEG), and, therefore, could likewise be charged by keeping the card near the intended subject's living body for an extended period of time. FIGS. 18-20 illustrate such a self-powered memorial card 180, and FIG. 21 illustrates the method by which a user personalizes it to complete the creation of a personal energy memorial of this third representative embodiment type.

A self-powered memorial card 180, built on a plastic celluloid card of credit card form factor, has the TEG 110 of FIG. 11 mounted in a cutout space that corresponds substantially in size and dimensions to the TEG 110, exposing the TEG's 110 cold side 1102 at the front of the self-powered memorial card 180 and the hot side 1101 at the back. To reduce redundancy, the self-powered memorial card of this third embodiment may hereinafter alternately be referred to as “the card 180.” The front of the card 180 further comprises an electroluminescent (EL) sheet 181, cut in the shape of a hot air balloon, with an illustration of a hot air balloon printed on it. This self-powered memorial card 180 perhaps memorializes a subject who in life was fascinated with hot air balloons; or perhaps the hot air balloon image represents something about the subject's life, personality, or spirit. Indicia 182 relevant to the subject's life could complement the hot air balloon theme. A dome switch 183, when pressed, operates the EL sheet 181.

A second dome switch 185, disposed on a detachable tab 184, allows a user to selectably enable or disable the flow of electrical current from the TEG 110 to the card's 180 rear-mounted stack of ten micro-energy cells (MEC's) 190, thereby facilitating or preventing charging of the MEC's 190 with energy harvested by the TEG 110. A user can also permanently disable the charging circuit link between the TEG 110 and the MEC's 190 by tearing away the detachable tab 184, thereby severing the second dome switch's 185 operational circuitry, leaving the circuit permanently open. A power management integrated circuit (PMIC) 191 manages the charging and discharging of the MEC's 190. A separate circuit enables the EL sheet 181, which is powered by the MEC's 190 via the PMIC 191 and an EL driver 192, which conditions the MEC's 190 voltage output to make it suitable for illuminating the EL sheet 181. Ideally, the EL driver 192 would be configured such that it would “fade in” and “fade out” the EL sheet 181, a better effect than the otherwise abrupt on/off operation.

Before harvesting the memorial subject's personal energy, a user would first fully discharge the stacked MEC's 190 so as to drain the cells of the electrical energy added to them in manufacture. To accomplish this, the user would press the dome switch 183 to power the EL sheet 181, letting it drain the MEC's 190 until the light of the EL sheet 181 goes out, indicating that the MEC's 190 are fully discharged.

When ready to harvest the subject's personal energy, the user presses the second dome switch 185, prompting the PMIC 191 to allow electrical energy generated by the TEG 110 to flow to and charge the MEC's 190. When the MEC's 190 have been fully or sufficiently charged, the user can tear away the detachable tab 184 from the card 180, thereby permanently disabling the self-powered memorial card's 180 personal energy harvesting function. This step would ensure that the card 180 could not be used again to harvest energy from any other person or animal, nor be influenced by any incidental ambient thermal temperature differences that the integrated TEG 110 might convert to electrical current, which could inadvertently charge the MEC's 190. Also, with the detachable tab 184 removed, the self-powered memorial card 180 is of a credit card form factor and suitable for carrying in a wallet, purse, organizer or such. The detachable tab 184 should be made of a flexible material that can fold forward or backward so that it doesn't “get in the way” or otherwise cause inconvenience while the card 180 is being kept near the subject's body in the harvesting step of the self-powered card memorial's personalization. On the other hand, the detachable tab's 184 connection to the card 180 should be substantial enough that it does not break off prematurely; it should require intentional effort, but not undue strength or dexterity, to tear the detachable tab 184 away.

To help the user determine when the self-powered memorial card's 180 mounted MEC's 190 have been fully charged, the manufacturer of the card 180 could give guidelines that suggest how long the card 180 should be kept in proximity or contact with the subject's warm body under various conditions. A “fuel gauge” in the card's 180 design is another possible solution. If included, the fuel gauge should be disposed on the detachable tab 184 so that it too can be permanently removed once the user is satisfied with the card's 180 charge status; configured otherwise, it is likely that the fuel gauge would continue to operate and thereby require some energy from the MEC's 190. Since it is an aim of the present invention to provide a method that makes it possible for a survivor to keep a store of their deceased loved one's personal energy as part of a memorial for a very long time, even the tiny amount of energy a micro, integrated circuit type fuel gauge would draw from the irreplaceable store of harvested personal energy held by the MEC's 190 should be considered carefully.

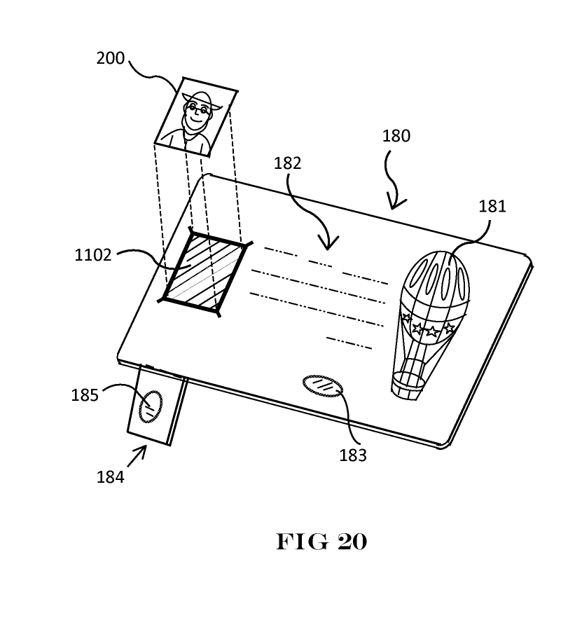

To improve the aesthetic appearance of the front of the card 180, it is proposed that an image or additional indicia be printed or adhered to the planar surface of the TEG's 110 cold side 1102, as illustrated in FIG. 20, in which a photograph 200 of the self-powered memorial card's 190 subject is shown being applied there.

The advantage of including an onboard energy harvesting device in the design of a self-powered memorial card 180 or a self-charging battery card 120 is that a user is not tied to a charging station but rather can harvest energy from their own or a loved one's body while they or the loved one go about their daily activities. A challenge, however, presented by these designs and the method is costs: the cost that the harvesting device itself adds to the card 180, and the cost of the environmental impact of manufacturing a harvesting device for each and every such card. An alternate charging solution overcomes this challenge: a portable, wearable charging station that comprises one or more energy harvesting devices could charge a battery card 11 or a powered memorial card 150.

For example, several thermoelectric generators (TEG) and/or piezoelectric harvesting devices could be arrayed in a wearable garment. The garment would have means for electrically connecting with a battery card 11 or powered card 150, and vice versa, (the latter devices likely requiring reconfiguration for use in this alternate arrangement). When worn, the garment would harvest thermal and/or kinetic energy from the wearer's body, which could be used to charge a battery card 11 or powered card memorial 150. Other wearable items could be outfitted similarly, such as a hat, a card that can be kept in a pocket or clipped on a belt, a so-called “fanny pack”, or a backpack. This solution offers the portability convenience gained with the self-charging battery card 120 and self-powered memorial card 180's designs, but at the lower per-card costs, price and environmental-wise, that exists with the battery card 11 and the powered memorial card 150. The overall costs to the user could also be lower, depending on the number of such cards a user would want to personalize. Again, decisions in this regard will be made by producers in response to the needs and desires expressed by users.

Other alternative approaches for associating harvested personal energy with a memorial to create a personal energy memorial are, of course, possible. One such alternative involves adding to an otherwise conventional memorial an accessory item that comprises all components necessary to harvest, store and use personal energy. For example, after having been worn by the subject of a memorial and thereby having harvested a store of the subject's personal energy, a bracelet that comprises a piezoelectric module that harvests energy from the wearer's movement, a thin-film battery, a light emitting diode (LED) and an enabling circuit could be secured to or with, or otherwise associated with, a conventional memorial to yield a personal energy memorial. A survivor of the deceased could remove the suggested bracelet from the memorial occasionally to wear it him- or herself and to experience the subject's stored personal energy through the light emitted by the evincing electronic, the LED. Bracelets, pendants, religious items, statues, figurines, coins, and cards (such as the powered cards described above) are some of the accessories that could be used to realize this alternative approach.

The self-powered memorial card described above as the third representative embodiment represents yet another alternative approach, wherein items which comprise at least an energy harvesting module capable of harvesting energy from a living person or animal, means to store the energy harvested by the harvesting module, and an electronic device powered by this stored energy to produce an output that engages human senses and/or emotions could themselves be personal energy memorials. Design elements of such items, structural and superficial, in addition to marketing intent would set them apart from other similar items. This scheme could easily be extended to any item that can be worn or brought into direct or indirect contact with a living person or animal's body. Some likely but not limited choices are items that are commonly worn already, such as jewelry or articles of clothing.

A personal energy memorial could also simply comprise or be associated with a store of harvested personal energy alone; the memorial need not comprise or be part of a system that comprises an electronic device. Some survivors may value only having a store of their deceased loved one's harvested personal energy and not need or desire to have it evinced through electronics.

In practice, the energy that is harvested and added to a personal energy memorial will generally be that of one person or animal. However, a memorial of the present invention could hold and/or make use of a store or stores of energy harvested from more than one person, more than one animal, or a combination thereof. For example, a personal energy memorial could hold or use two or more separate energy storage devices, each comprising an exclusive store of energy from one of two or more individual people and/or animals. This would yield a collective personal energy memorial.

If the memorial further comprised an evincing electronic device or devices, then in such a collective arrangement the separate stores of energy could power the same electronic device, each store of energy could power a separate and dedicated electronic device, or some combination thereof. In another form of a collective personal energy memorial, the energy of more than one person or animal, or both, could be harvested and stored in the same energy storage device. The individual personal energy harvested for a collective memorial could be harvested in a single process wherein all of the subjects of the collective memorial have their personal energy harvested in the same process at the same time; it could be harvested in the same process but at different times; or, it could be harvested in different processes at the same or different times.

Collective personal energy alternatives may appeal to people who in life had an intimate or otherwise very close relationship and would like to continue to express their emotional bond after life by commingling their energy in a collective memorial; couples, family members, teammates, soldiers, and classmates, for example. Also, a collective memorial may appeal to a pet owner who has more than one pet and would like to have a single memorial in which to keep and/or evince personal energy harvested from each. A pet owner who shares an especially close emotional bond with their pet may want to memorialize their own and their pet's lives in a single personal energy memorial, in one of the collective arrangements described above.

Personal energy can be harvested firsthand, i.e. by the person who is the subject of the memorial from his or her own body; or, it can be harvested secondhand, i.e. from the body of another person or that of an animal. The place or area of the body from which personal energy is harvested can be left to a user to decide. When the thermal energy of a person's body heat is harvested for personal energy memorial purposes, the preferred site of harvest is the palm of the person's hand, as the touch of one's hand communicates so much in life. Still, there are areas of the human body that emanate heat more intensely than the palm and thus could be considered more suitable harvesting sites for thermal harvesting; the same is true of an animal's body. Also, there could be areas of the body that are aesthetically, emotionally or sentimentally relevant to a user and the life they or a loved one lived which could influence his or her harvesting preferences.

At present, the capacity of individual thin-film batteries, while impressive given their wafer-like dimensions, is not great, relatively. By stacking the batteries in parallel, as done with the representative embodiments described herein, however, greater capacity can be built. Of course, other battery types with higher amp hour ratings could be used in a variety of other designs for applications of the present invention requiring more powerful batteries; however, the additional capacity gained should be weighed against a likely much shorter charged shelf life than the stated preferred micro-energy cells and possibly limited energy harvesting options that may result as well from such a battery choice.

In the end, makers of the present invention will choose an energy storage device that best suits their and their client's particular needs and preferences. As energy storage technology develops, another type or brand of energy storage device may offer more to the present invention than micro-energy cells. Ideal would be an energy storage device that can hold a charge indefinitely. While there are some developments leading to such permanent energy storage, especially by chemical means, none appears quite ready for practical application in the present invention at this time; however, when and where such developments can be used to store harvested personal energy, they can be used to create a personal energy memorial of the present invention.

Preferably, a personal energy memorial will comprise or have as an accessory an item that comprises at least one electronic device that is powered by an energy storage device which has been charged with the harvested personal energy of the memorial's subject. A personal energy memorial that comprises and/or has accessory to it more than one electronic device could have all of the devices powered by a store of the subject's harvested personal energy; or, one or more of the electronic devices could be powered by the harvested personal energy while another or other electronic devices are powered by a separate, conventionally charged electrical energy storage device (i.e. one not comprising a store of harvested personal energy). For example, a personal energy memorial could comprise an electronic device that produces an audio output and another that features an LED light display. While a battery that is charged with the memorial subject's harvested personal energy could power the LED light, an off-the-shelf battery that's been charged conventionally could power the audio component. This arrangement would yield a hybrid personal energy memorial.

Throughout the detailed descriptions above, the representative embodiments have involved the use of a credit-card sized celluloid plastic card as a substrate means for various arrangements of electronic devices. Keeping this factor constant has allowed the focus of the disclosure to be on the described permutations of a basic method that includes harvesting, converting, storing and using personal energy to personalize a memorial. It will be understood that where a card has been the described medium for configuring the components necessary to effect this basic method, other items could be used as the medium instead. For example, jewelry items that are commonly worn, such as bracelets, necklaces or pendants, could be configured similarly and fulfill similar roles as those accomplished by the various card designs described above. Wherever a card is referred to above, any suitable other physical medium that can be outfitted similarly could be and is alternately referred to by implication herein.

Representative embodiments of the present invention have been shown, and preferences and guidance for creating the same have been given, all with the aim of providing information that can help those skilled in the relevant arts actualize the concept and teachings of the present invention. With the aforementioned depictions serving to represent and exemplify, it will be appreciated by those skilled in the art that these depictions are made by way of example only, that the invention is not limited to the particular embodiments described in this disclosure, and that various adaptations, changes, configurations, and substitutions may be made in any practical application of the present invention without departing from the principles and spirit of the representative embodiments nor the scope of the invention as hereinafter claimed.

What is claimed is:

1. A method for personalizing a memorial, the method comprising:
providing a memorial; and
associating said memorial with one or more chargeable electrical energy storage devices that have been charged directly or indirectly with electrical power generated by at least one energy harvesting device, wherein said at least one energy harvesting device generates said electrical power by harvesting energy from the living body or bodies of one or more persons and/or animals and converting said energy to said electrical power.

2. The method of claim 1, wherein the said one or more chargeable electrical energy storage devices are standalone devices or are part of another or other devices.

3. The method of claim 1, wherein the associating step is the only way the memorial is personalized, or wherein the memorial is or can be additionally personalized in another or other preceding or subsequent ways.

4. The method of claim 1, wherein some of the steps are accomplished by one party while other of the steps are accomplished by another party or parties, or wherein all of the steps are accomplished by one party alone.

5. The method of claim 1, wherein the memorial comprises at least one retaining structure and/or space for keeping the said one or more chargeable electrical energy storage devices in, on or with the memorial.

6. The method of claim 5, wherein the associating step is accomplished by placing in, on or with the retaining structure the said one or more chargeable electrical energy storage devices.

7. The method of claim 1, wherein the memorial comprises at least one electronic device, said electronic device capable of producing an output that directly or indirectly stimulates one or more of the human senses.

8. The method of claim 7, wherein the association step is accomplished by electrically and operably connecting, directly or indirectly, the at least one electronic device with the said one or more chargeable electrical energy storage devices.

9. The method of claim 8, wherein the at least one electronic device can be selectably powered by the one or more chargeable electrical energy storage devices.

10. The method of claim 7, wherein the memorial further comprises the one or more chargeable electrical energy storage devices.

11. The method of claim 10, wherein the memorial further comprises means for electrically connecting, directly or indirectly, the one or more chargeable electrical energy storage devices to at least one external energy harvesting device, said means enabling the one or more chargeable electrical energy storage devices to be charged, directly or indirectly, with electrical power generated by the said at least one external energy harvesting device.

12. The method of claim 11, wherein the association step is accomplished by charging the one or more chargeable electrical energy storage devices directly or indirectly with electrical power generated by the at least one external energy harvesting device, wherein the said at least one external energy harvesting device generates said electrical power by harvesting energy from the living body or bodies of one or more persons and/or animals and converting said energy to said electrical power.

13. The method of claim 10 wherein said memorial further comprises at least one energy harvesting device, the at least one energy harvesting device electrically connected, directly or indirectly, to the said one or more chargeable electrical energy storage devices, wherein the one or more chargeable electrical energy storage devices can be electrically charged, directly or indirectly, by electrical power generated by the at least one energy harvesting device.

14. The method of claim 13, wherein association step is accomplished by charging the one or more chargeable electrical energy storage devices directly or indirectly with electrical power generated by the at least one energy harvesting device, wherein the at least one energy harvesting device generates said electrical power by harvesting energy from the living body or bodies of one or more persons and/or animals and converting said energy to said electrical power.

15. A memorial product comprising an energy harvesting device capable of harvesting energy from the living body of a human being or animal.

16. The method of claim 1, wherein the one or more chargeable electrical energy storage devices are discharged to the maximum extent possible prior to said devices being charged.
